(19) United States
(12) Patent Application Publication
(10) Pub. No.: US 2023/0334486 A1
(43) Pub. Date: Oct. 19, 2023

(54) INFORMATION PROCESSING APPARATUS, ASSET MANAGEMENT APPARATUS, INFORMATION PROCESSING METHOD, ASSET MANAGEMENT METHOD, AND RECORDING MEDIUM

(71) Applicant: ANIFIE, INC., Irvine, CA (US)

(72) Inventors: Yohei IWASAKI, Irvine, CA (US); Claudio Jesus TORRES, Barcelona (ES)

(21) Appl. No.: 18/299,128

(22) Filed: Apr. 12, 2023

Related U.S. Application Data
(60) Provisional application No. 63/331,046, filed on Apr. 14, 2022.

(51) Int. Cl. G06Q 20/38; A63F 13/825; G06Q 20/40

(52) U.S. Cl. CPC G06Q 20/389; A63F 13/825; G06Q 20/401

(57) ABSTRACT

The present invention solves the conventional problem that it is not possible to use one specific asset such as an avatar in two or more metaverses. An information processing apparatus for realizing one metaverse includes: an instruction receiving unit that receives an asset instruction, which is an instruction to use a specific asset; an asset acquiring unit that acquires compatible asset information corresponding to the one metaverse and the specific asset, from an asset storage unit in which compatible asset information regarding a compatible asset corresponding to one asset is stored in association with each of two or more metaverses; an asset configuring unit that configures a compatible asset that is used in the one metaverse, using the compatible asset information acquired by the asset acquiring unit; and an asset output unit that outputs the compatible asset configured by the asset configuring unit.

### CROSS-REFERENCE TO RELATED APPLICATIONS

This non-provisional application claims priority to U.S. Provisional Patent Application 63/331,046, filed Apr. 14, 2022, the entire disclosure of which is incorporated herein by reference.

### TECHNICAL FIELD

The present invention relates to an information processing apparatus or other suitable apparatuses for outputting assets such as avatars in metaverses.

### BACKGROUND ART

Conventionally, there exist information management apparatuses for managing information on avatars in a metaverse (see Patent Document 1, for example).

This information management apparatus is an information management apparatus including: a static information acquiring means for acquiring static information held by an avatar; a dynamic information acquiring means for acquiring dynamic information based on an action of the avatar; and an avatar information storage means in which the static information and the dynamic information are stored in association with the avatar.

### CITATION LIST

### Patent Document

Patent Document 1: JP 2011-216073A

### SUMMARY OF THE INVENTION

### Technical Problem

Using existing technologies, it is not possible to use an asset such as an avatar in two or more metaverses.

The reasons why it is not possible to use one specific asset in two or more metaverses are (1) through (4) below, for example.
(1) The standard asset size differs according to a metaverse.
(2) The optimal asset weight (capacity) differs according to a metaverse.
(3) The style such as painting style differs according to a metaverse.
(4) If assets are stored on a blockchain, the compatible blockchain differs according to a metaverse, and thus assets that can be displayed are limited.

In view of these problems, it is an object of the invention of the present application to make it possible to use a specific asset in two or more metaverses, by using an asset compatible with each of the two or more metaverses.

In the invention of the present application, two or more assets corresponding to a specific asset do not have to be the same in appearance as the specific asset.

### Solution to the Problem

A first aspect of the present invention is directed to an information processing apparatus for realizing one metaverse, including: an instruction receiving unit that receives an asset instruction, which is an instruction to use a specific asset; an asset acquiring unit that acquires compatible asset information corresponding to the one metaverse and the specific asset, out of two or more pieces of compatible asset information corresponding to the specific asset; an asset configuring unit that configures a compatible asset that is used in the one metaverse, using the compatible asset information acquired by the compatible asset acquiring unit; and an asset output unit that outputs the compatible asset configured by the asset configuring unit.

By utilizing this first configuration, for a specific asset, it is possible to use an asset suitable for a metaverse that is operated by each information processing apparatus.

A second aspect of the present invention is directed to the information processing apparatus according to the first aspect, wherein the asset acquiring unit acquires the compatible asset information from an asset storage unit in which compatible asset information regarding a compatible asset corresponding to one asset is stored in association with each of two or more metaverses.

By utilizing this second configuration, for a specific asset, it is possible to use an asset suitable for a metaverse that is operated by each information processing apparatus. A third aspect of the present invention is directed to the information processing apparatus according to the second aspect, wherein two or more pieces of compatible asset information are stored in the asset storage unit in association with the one metaverse and the one asset, the asset instruction has an asset identifier for identifying one piece of compatible asset information out of the two or more pieces of compatible asset information, and the asset acquiring unit acquires the compatible asset information corresponding to the one metaverse and the one asset corresponding to the asset instruction and identified with the asset identifier, from the asset storage unit.

By utilizing this third configuration, for a specific asset, it is possible for a user to select and use one asset out of two or more assets compatible with one metaverse.

A fourth aspect of the present invention is directed to the information processing apparatus according to the second or third aspect, wherein rights information for specifying a user who is allowed to use the compatible asset information is managed in association with the compatible asset information in the asset storage unit, the instruction receiving unit receives the asset instruction in association with a user identifier for identifying a user, the information processing apparatus further includes a first determining unit that determines whether or not the user identified with the user identifier corresponding to the asset instruction is allowed to use the compatible asset information, using the rights information associated with the compatible asset information corresponding to the one metaverse and the one asset corresponding to the asset instruction, and the asset output unit outputs the compatible asset only in a case in which the first determining unit determines that the user is allowed to use the compatible asset information.

By utilizing this fourth configuration, only a user who has a right to use a compatible asset can use the compatible asset.

A fifth aspect of the present invention is directed to the information processing apparatus according to the fourth aspect, wherein the two or more pieces of compatible asset information and the rights information are managed using a mechanism of a blockchain, and the first determining unit refers to the rights information managed in the blockchain and determines whether or not the user is allowed to use the compatible asset information.

By utilizing this fifth configuration, blockchain techniques are used for managing compatible assets, and thus it is possible to properly manage one asset and a compatible asset corresponding to the one asset.

A sixth aspect of the present invention is directed to an asset management apparatus including: an asset storage unit in which two or more pieces of compatible asset information are stored in association with any one metaverse identifier of two or more metaverse identifiers and any one asset identifier of one or more asset identifiers; a request receiving unit that receives an asset request that specifies one metaverse identifier and one asset identifier; an asset determining unit that determines compatible asset information corresponding to the one metaverse identifier and the one asset identifier specified with the asset request, from the asset storage unit; and an asset transmitting unit that transmits the compatible asset information determined by the asset determining unit.

By utilizing this sixth configuration, it is possible to provide a platform for making it possible to use a specific asset in each of two or more metaverses.

A seventh aspect of the present invention is directed to the asset management apparatus according to the sixth aspect, further including: a registration instruction receiving unit that receives a registration instruction, which is an instruction to register compatible asset information regarding a compatible asset using the one asset, the registration instruction specifying one metaverse identifier; and a registration unit that accumulates the compatible asset information in the asset storage unit in association with the one metaverse identifier and the asset identifier of the one asset, in response to receipt of the registration instruction.

By utilizing this seventh configuration, it is possible to register a compatible asset.

An eighth aspect of the present invention is directed to the asset management apparatus according to the seventh aspect, further including: a second determining unit that determines whether or not it is possible to perform reward processing, which is processing for providing a reward for the one asset, in response to accumulation of the compatible asset information by the registration unit, wherein the registration unit registers the compatible asset information in the asset storage unit only in a case in which the second determining unit determines that it is possible to perform reward processing.

By utilizing this eighth configuration, it is possible to properly perform an operation for registering a compatible asset.

A ninth aspect of the present invention is directed to the asset management apparatus according to any one of the sixth to eighth aspects, wherein a right holder identifier for identifying a right holder of an asset is managed in association with the one asset and each of the compatible assets, and the asset management apparatus further includes: a purchase instruction receiving unit that receives a purchase instruction on a compatible asset; and a reward processing unit that performs processing for providing a reward to both a right holder identified with a right holder identifier that is paired with the compatible asset corresponding to the purchase instruction and a right holder identified with a right holder identifier that is paired with the one asset that is paired with the compatible asset.

By utilizing this ninth configuration, it is possible to provide a mechanism for properly providing a reward to a right holder of an original asset in the case in which a compatible asset is sold.

A tenth aspect of the present invention is directed to the asset management apparatus according to any one of the sixth to ninth aspects, wherein the asset storage unit is a recording medium in a blockchain. In the asset management apparatus, for example, all or any of the asset storage unit, the second determining unit, the registration instruction receiving unit, the purchase instruction receiving unit, the reward processing unit, the asset determining unit, and the asset transmitting unit uses a mechanism of a blockchain.

By utilizing this tenth configuration, it is possible to properly manage compatible assets and any other suitable assets, using a mechanism of a blockchain.

### Advantageous Features of the Invention

In accordance with the information processing apparatus and method of the present invention, for a specific asset, it is possible to use an asset suitable for a metaverse that is operated by the information processing apparatus.

### BRIEF DESCRIPTION OF THE DRAWINGS

FIG. 1 is a conceptual diagram of an information system A in Preferred Embodiment 1.

FIG. 2 is a block diagram of the information system A in the preferred embodiment.

FIG. 3 is a block diagram of an asset management apparatus 1 in the preferred embodiment.

FIG. 4 is a flowchart illustrating an operation example of the asset management apparatus 1 in the preferred embodiment.

FIG. 5 is a flowchart illustrating an example of second determination processing in the preferred embodiment.

FIG. 6 is a flowchart illustrating an operation example of an information processing apparatus 2 in the preferred embodiment.

FIG. 7 is a flowchart illustrating an operation example of a terminal apparatus 3 in the preferred embodiment.

FIG. 8 is a diagram showing an asset management table in the preferred embodiment.

FIG. 9 is a schematic view of a computer system in the preferred embodiment.

FIG. 10 is a block diagram of the computer system in the preferred embodiment.

### DESCRIPTION OF THE PREFERRED EMBODIMENT

Below, a preferred embodiment of the information processing apparatus and its components and variants will be described with reference to the drawings. The constituent elements denoted by the same reference numerals in the embodiments described below perform similar operations, and thus a description thereof may not be repeated.

### Preferred Embodiment 1

In this preferred embodiment, an information processing apparatus will be described in which a compatible asset is managed for each of two or more metaverses, and, in the case of using one asset in one metaverse, a compatible asset compatible with the one metaverse can be used. The compatible asset is an asset corresponding to the one asset. The compatible asset is an asset created based on the one asset, for example. The compatible asset is an asset derived from the one asset, for example.

Furthermore, in this preferred embodiment, an information processing apparatus will be described in which two or more compatible assets corresponding to one asset are managed for one metaverse, and a user can select and use one compatible asset out of the two or more compatible assets.

Furthermore, in this preferred embodiment, an asset management apparatus will be described that manages a compatible asset corresponding to one asset for each of two or more metaverses.

Furthermore, in this preferred embodiment, an asset management apparatus will be described that includes a mechanism in which it is determined whether or not a user has a right to use a compatible asset, and only a user who has the right is allowed to use the compatible asset.

A metaverse is a three-dimensional virtual space built in a computer or computer network. A metaverse may be referred to as other names such as world or field.

Furthermore, an asset is an object that appears in a metaverse. An asset is an avatar, a mobile object such as a vehicle, a building, or a component of a building, for example. The term “asset” used in this specification may refer to a distributed ledger (blockchain) that refers to or manages the above-mentioned object.

Furthermore, in this preferred embodiment, an asset management apparatus will be described that provides a mechanism for registering a compatible asset.

Furthermore, in this preferred embodiment, an asset management apparatus will be described that provides a mechanism for properly providing a reward to a right holder of an original asset as well in the case in which a compatible asset is sold.

In this embodiment, the state in which information X is associated with information Y means that the information Y can be acquired from the information X or the information X can be acquired from the information Y, and there is no limitation on the method for associating the information. The information X and the information Y may be linked to each other or in the same buffer. The information X may be contained in the information Y, or the information Y may be contained in the information X, for example.

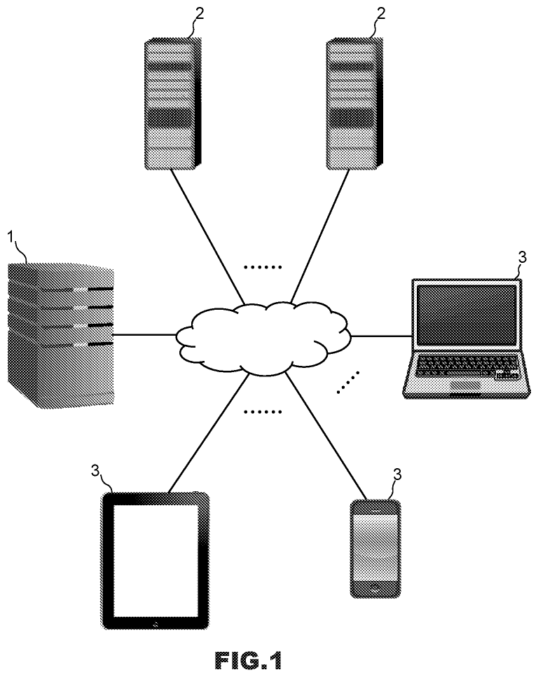

FIG. 1 is a conceptual diagram of an information system A in this preferred embodiment. The information system A includes an asset management apparatus 1, one or more information processing apparatuses 2, and one or more terminal apparatuses 3.

The asset management apparatus 1 is an apparatus that manages two or more pieces of compatible asset information corresponding to one asset. The asset management apparatus 1 is preferably an apparatus that configures a blockchain. The asset management apparatus 1 is preferably an apparatus that realizes a distributed ledger. The asset management apparatus 1 is preferably an NFT (non-fungible token) and an asset storage unit 111 is preferably an interplanetary file system (IPFS). The asset management apparatus 1 may be distributed across two or more apparatuses, or may overlap across two or more apparatuses. The asset management apparatus 1 is referred to as a server, for example, and is a cloud server, an application service provider (ASP) server, or any other suitable asset management apparatus, for example. There is no limitation on the type of the asset management apparatus 1.

The information processing apparatuses 2 are servers that realize metaverses. The information processing apparatuses 2 are typically referred to as servers, and are cloud servers, ASP servers, or any other suitable information processing apparatuses, for example. All or some of the information processing apparatuses 2 may be blockchains. For example, an asset acquiring unit 232 may be a distributed ledger (blockchain) such as Ethereum or Polygon, and this distributed ledger may refer to the asset management apparatus 1 and acquire compatible asset information. For example, if the asset acquiring unit 232 is a distributed ledger, an asset configuring unit 233 may be a server, and the asset configuring unit 233 may acquire a compatible asset from an IPFS based on a blockchain address acquired by the asset acquiring unit 232 and pass it to an asset output unit 241. The units such as the asset acquiring unit 232 or the asset configuring unit 233 may exist across multiple information processing apparatuses and across multiple information processing apparatus owners or distributed ledgers. It is assumed that the information processing apparatuses 2 are conceivable in such a case as well. There is no limitation on the type of the information processing apparatuses 2.

The terminal apparatuses 3 are terminals that are used by users. The users are users who use assets such as avatars in metaverses, users who request to register compatible asset information, or users who purchase compatible assets, for example. The terminal apparatuses 3 are referred to as personal computers, tablet devices, smartphones, or any other suitable terminal apparatuses, for example. There is no limitation on the type of the terminal apparatuses 3.

The asset management apparatus 1 and each of the one or more information processing apparatuses 2, the asset management apparatus 1 and each of the one or more terminal apparatuses 3, and each of the one or more information processing apparatuses 2 and each of the one or more terminal apparatuses 3 can preferably communicate with each other via a network such as the Internet.

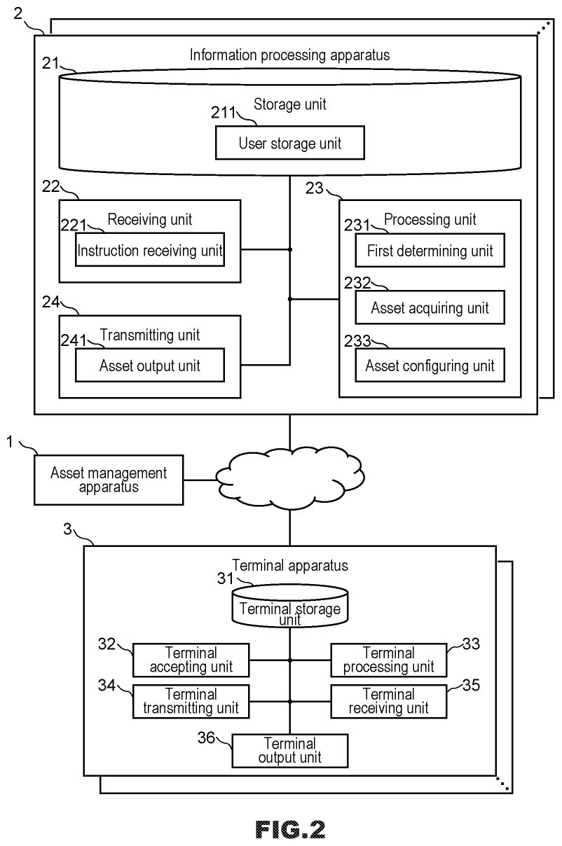

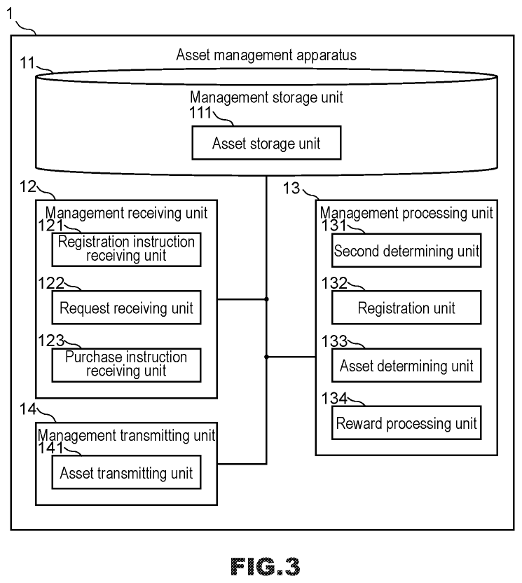

FIG. 2 is a block diagram of the information system A in this preferred embodiment. FIG. 3 is a block diagram of the asset management apparatus 1.

The asset management apparatus 1 includes a management storage unit 11, a management receiving unit 12, a management processing unit 13, and a management transmitting unit 14. The management storage unit 11 includes an asset storage unit 111. The management receiving unit 12 includes a registration instruction receiving unit 121, a request receiving unit 122, and a purchase instruction receiving unit 123. The management processing unit 13 includes a second determining unit 131, a registration unit 132, an asset determining unit 133, and a reward processing unit 134. The management transmitting unit 14 includes an asset transmitting unit 141.

Each information processing apparatus 2 includes a storage unit 21, a receiving unit 22, a processing unit 23, and a transmitting unit 24. The storage unit 21 includes a user storage unit 211. The receiving unit 22 includes an instruction receiving unit 221. The processing unit 23 includes a first determining unit 231, an asset acquiring unit 232, and an asset configuring unit 233. The transmitting unit 24 includes an asset output unit 241.

Each terminal apparatus 3 includes a terminal storage unit 31, a terminal accepting unit 32, a terminal processing unit 33, a terminal transmitting unit 34, a terminal receiving unit 35, and a terminal output unit 36.

Various types of information are stored in the management storage unit 11 constituting the asset management apparatus 1. The various types of information are preferably compatible asset information and rights information as described below, for example.

Two or more pieces of compatible asset information are stored in the asset storage unit 111. The compatible asset information in the asset storage unit 111 is associated with one metaverse and one asset. The one asset in this case is an original asset from which the compatible asset information was created, for example. The asset storage unit 111 is preferably a recording medium in a blockchain or a recording medium constituting a distributed ledger. The asset storage unit 111 may be distributed across two or more apparatuses, or may overlap across two or more apparatuses.

Two or more pieces of compatible asset information are stored in the asset storage unit 111 in association with any one metaverse identifier of two or more metaverse identifiers and any one asset identifier of one or more asset identifiers, for example.

The compatible asset information is an example of asset information. The compatible asset information preferably consists of information regarding a compatible asset. Another asset is associated with the compatible asset. An original asset from which the compatible asset was created is associated with the compatible asset. The compatible asset may be an asset derived from the original asset. The compatible asset is an asset created using the original asset, for example. The compatible asset information preferably consists of a derivative work of original asset information that is a creative work, for example. The original asset information preferably consists of information for displaying the original asset.

Typically, the asset information preferably consists of information for displaying an asset. The information for displaying an asset may also be said to be asset configuring information. The asset information may be link information for accessing asset configuring information or information for specifying the location of asset configuration information (e.g., a URL, a URI, or a blockchain address), for example. Therefore, there is no limitation on the structure of asset information.

The asset configuring information or the asset information preferably consists of avatar information for displaying an avatar, for example. The avatar information has model information. The model information preferably consists of information for configuring the display of an avatar. The model information has mesh information, bone information, and material information, for example. The model information has a GL transmission format (glTF) data structure, for example. The data structure of the model information may be value request manager (VRM), object (OBJ), filmbox (FBX), standard triangle language (STL), generic logic block (GLB), collaborative design activity (COLLADA), or any other suitable data structures. There is no limitation on the type of the data structure. Therefore, there is no limitation on the structure of the asset configuring information.

The compatible asset information in the asset storage unit 111 is associated with a metaverse identifier, an asset identifier, a user identifier, and rights information, for example.

The metaverse identifier preferably consists of information for identifying a metaverse. The metaverse identifier is a metaverse ID, a metaverse name, or access information for accessing a metaverse (e.g., a URL, of a URI), for example.

Furthermore, the asset identifier preferably consists of information for identifying an asset. The asset identifier is an asset ID, an asset name, or access information for accessing an asset (e.g., URL, a URI, or a blockchain address), for example.

The rights information preferably consists of information regarding a right related to an asset. The rights information preferably consists of information for specifying a user who has a right related to an asset, for example. The rights information preferably consists of owner information, user information, or copyright holder information, for example. The owner information preferably consists of information for specifying an owner of asset information. The user information preferably consists of information for specifying a user who can use asset information. The copyright holder information preferably consists of information regarding a copyright holder of an asset, and is information for specifying a person who has author's moral rights of an asset or a person who has author's property rights, for example. The rights information has user identifiers of one or more users for specifying a right holder (an owner or a user) of an asset, for example. The rights information has a flag indicating that a user can use asset information, for example. The rights information has a flag indicating that a user can serve as an original asset from which a compatible asset is created, for example. The rights information has a flag indicating that an asset may be for sale, for example.

The rights information is preferably associated also with the original asset information corresponding to the compatible asset information.

The management receiving unit 12 receives various types of instructions and information. The various types of instructions and information are preferably a registration instruction, an asset request, and a purchase instruction as described below, for example.

The registration instruction receiving unit 121 receives a registration instruction. The registration instruction receiving unit 121 receives a registration instruction from the information processing apparatus 2 or the terminal apparatus 3, for example.

The registration instruction preferably consists of an instruction to register compatible asset information. The registration instruction preferably consists of an instruction corresponding to a metaverse identifier for identifying a metaverse in which compatible asset information is to be used. The registration instruction is associated with an asset identifier for identifying original asset information. The registration instruction is associated with a user identifier, for example.

The request receiving unit 122 receives an asset request. The request receiving unit 122 receives an asset request from the information processing apparatus 2 or the terminal apparatus 3, for example.

The asset request preferably consists of a request to use asset information. The asset request preferably consists of a request to use compatible asset information, for example. The asset request is associated with one metaverse identifier and an asset identifier of one original asset, for example. The asset request is associated with an asset identifier for identifying one piece of compatible asset information, for example.

The purchase instruction receiving unit 123 receives a purchase instruction on a compatible asset. The purchase instruction on a compatible asset may also be said to be a purchase instruction on compatible asset information. The purchase instruction is associated with an asset identifier for identifying a compatible asset. The purchase instruction is preferably associated with a user identifier for identifying a purchaser.

The management processing unit 13 performs various types of processing. The various types of processing are preferably processing that is performed by the second determining unit 131, the registration unit 132, the asset determining unit 133, and the reward processing unit 134, for example.

The second determining unit 131 determines whether or not a user identified with the user identifier corresponding to the received asset request can use a compatible asset corresponding to the asset request, for example. The second determining unit 131 acquires rights information that is paired with a compatible asset identifier corresponding to the received asset request, and determines whether or not a user identified with the user identifier corresponding to the asset request can use the compatible asset, based on the rights information, for example. For example, if user identifiers contained in the rights information that is paired with a compatible asset identifier corresponding to the received asset request include a user identifier corresponding to the asset request, the second determining unit 131 determines that the user can use the compatible asset.

The second determining unit 131 determines whether or not to perform reward processing, for example. The reward processing preferably consists of processing for, in the case in which the registration unit 132 accumulates compatible asset information, providing a reward for one asset (original asset) corresponding to the compatible asset information. The reason why the second determining unit 131 determines whether or not to perform reward processing is so that the registration of the compatible asset is permitted only when the reward processing can be performed.

The second determining unit 131 determines that reward processing can be performed, in the case in which permission information associated with one asset is information indicating that the registration of the compatible asset using the one asset as an original asset is permitted, for example. The second determining unit 131 determines that reward processing can be performed, in the case in which credit card information is registered in pair with a user identifier corresponding to the received registration instruction, for example. The second determining unit 131 determines that reward processing can be performed, in the case in which it is determined that a reward can be provided using a mechanism of a blockchain, in pair with a user identifier corresponding to the received registration instruction, for example. There is no limitation on the condition for the second determining unit 131 to determine that reward processing can be performed.

In response to receipt of the registration instruction, the registration unit 132 accumulates compatible asset information corresponding to the registration instruction, in the asset storage unit 111, in association with one metaverse identifier and an asset identifier of one asset (original asset).

The registration unit 132 accumulates the compatible asset information contained in the registration instruction, in the asset storage unit 111, in association with one metaverse identifier and one asset identifier specified with the registration instruction, for example.

The registration unit 132 preferably registers the compatible asset information in the asset storage unit 111 only in the case in which the second determining unit 131 determines that reward processing can be performed.

The asset determining unit 133 determines compatible asset information corresponding to one metaverse identifier and one asset identifier specified with the received asset request, from the asset storage unit 111. The determining compatible asset information is typically acquiring the compatible asset information. The determining compatible asset information may be any suitable processing that enables the compatible asset information to be transmitted.

The reward processing unit 134 performs reward processing. Specifically, the reward processing unit 134 performs processing for providing a reward to both a right holder identified with a right holder identifier that is paired with the compatible asset corresponding to the received purchase instruction and a right holder identified with a right holder identifier that is paired with the one asset that is paired with the compatible asset.

The reward processing preferably consists of processing for calculating a reward that is to be acquired by each right holder and outputting the reward of the right holder, for example. The reward processing preferably consists of processing for crediting the account of each right holder, for example. The reward processing preferably consists of processing for calculating a reward to each right holder and accumulating the reward in association with the right holder identifier, for example.

The reward processing unit 134 performs reward processing, which is processing for, in the case in which compatible asset information is registered, providing a reward to an owner of an original asset from which the compatible asset information was created, for example.

The reward processing preferably consists of processing for accumulating information (e.g., amount of money or points) for specifying a reward in association with a user identifier for identifying the owner of the original asset, for example. The reward processing preferably consists of processing for charging a user who registers the compatible asset information and giving the amount of the charge to the owner of the original asset, for example.

The management transmitting unit 14 transmits various types of information. The various types of information are preferably compatible asset information, for example.

The asset transmitting unit 141 transmits the compatible asset information determined by the asset determining unit 133. The asset transmitting unit 141 transmits the compatible asset information acquired by the asset determining unit 133, for example.

The asset transmitting unit 141 typically transmits the compatible asset information to the apparatus that transmitted the asset request. The apparatus that transmitted the asset request is the information processing apparatus 2 or the terminal apparatus 3, for example.

Various types of information are stored in the storage unit 21 constituting the information processing apparatus 2. The various types of information are preferably user information, metaverse information, and asset information as described below, for example.

The metaverse information preferably consists of information for configuring a metaverse. There is no limitation on the structure of the metaverse information.

The asset information preferably consists of information that enables assets to be represented in a metaverse.

One or more pieces of user information are stored in the user storage unit 211. The user information preferably consists of information regarding a user. The user information has a user identifier and one or more user attribute values, for example.

The user identifier preferably consists of information for identifying a user. The user identifier is a user ID, a user's name, a user's e-mail address, or a user's telephone number, for example. The user identifier may be a terminal identifier of a terminal apparatus that is used by a user, for example. The user identifier is preferably the address of a distributed ledger (blockchain) wallet. The terminal identifier is an IP address or a MAC address, for example.

The receiving unit 22 receives various types of instructions and information. The various types of instructions and information are preferably a metaverse instruction, an asset instruction, a login instruction, and various types of commands as described below, for example.

The login instruction preferably consists of an instruction to allow a user to log in to the metaverse operated by the information processing apparatus 2. A user identifier is associated with the login instruction, for example. The login instruction may be the same as a metaverse instruction described below.

The instruction receiving unit 221 receives various types of instructions. The various types of instructions are preferably a metaverse instruction and an asset instruction, for example.

The metaverse instruction preferably consists of an instruction to transmit metaverse information. The instruction receiving unit 221 receives a metaverse instruction from the terminal apparatus 3, for example. The instruction receiving unit 221 preferably receives a metaverse instruction in association with a user identifier. Transmission of metaverse information is transmission of information for configuring a metaverse that is to be output by the terminal apparatus 3. Transmission of metaverse information may be simply said to be transmission of a metaverse.

An asset instruction preferably consists of an instruction to use a specific asset. Using an asset can be thought of as using asset information. An asset identifier of an original asset is preferably associated with the asset instruction. The asset instruction is preferably an instruction that specifies one piece of compatible asset information out of the two or more pieces of compatible asset information corresponding to one metaverse and one original asset. An asset identifier of a compatible asset may be associated with the asset instruction. The instruction receiving unit 221 preferably receives the asset instruction in association with a user identifier.

The processing unit 23 performs various types of processing. The various types of processing are preferably processing that is performed by the first determining unit 231, the asset acquiring unit 232, and the asset configuring unit 233, for example.

The first determining unit 231 determines whether or not a user identified with the user identifier corresponding to the asset instruction is allowed to use the compatible asset information, using rights information associated with the compatible asset information. The compatible asset information in this case preferably consists of compatible asset information corresponding to the one metaverse and the one asset corresponding to the received asset instruction. The one asset is typically an original asset corresponding to the compatible asset information, but may also be a compatible asset. It is preferable that, in the case in which the first determining unit 231 configures a distributed ledger (blockchain) together with the asset acquiring unit 232, and one asset is managed in an NFT or other suitable type of distributed ledger, rights information of the one asset is read from the distributed ledger to determine whether or not the compatible asset can be used.

The first determining unit 231 preferably refers to the rights information managed in the blockchain and determines whether or not the user is allowed to use the compatible asset information. When the first determining unit 231 refers to the blockchain that manages the rights information (or the blockchain that manages the original asset), the blockchain referred to may be Ethereum, Polygon, or other suitable blockchains. The first determining unit 231 is preferably compatible with various types of blockchains in this manner.

The asset acquiring unit 232 acquires a compatible asset corresponding to one metaverse and a specific asset, from the asset storage unit 111. Acquiring a compatible asset from the asset storage unit 111 is typically acquiring compatible asset information from the asset management apparatus 1. Acquiring compatible asset information from the asset management apparatus 1 may be acquiring compatible asset information from the asset management apparatus 1 constituting a distributed ledger. Acquiring a compatible asset from the asset storage unit 111 is preferably acquiring compatible asset information managed in a blockchain. The asset management apparatus 1 is preferably a distributed ledger, and the asset storage unit 111 is preferably an NFT or other suitable type of distributed ledger (including an IPFS to which such distributed ledger refers). At this time, the asset storage unit 111 is preferably a distributed ledger that is different from the asset management apparatus 1. Also, the blockchain used by the asset storage unit 111 and the blockchain used by the asset management apparatus 1 may be completely different digital tokens. The asset storage unit 111 may be an NFT with digital assets respectively on multiple completely different types of digital tokens.

The asset acquiring unit 232 preferably acquires the compatible asset information corresponding to the one metaverse and the one asset corresponding to the received asset instruction and identified with the asset instruction, from the asset storage unit 111. The one metaverse corresponding to the asset instruction may be rephrased as a metaverse determined from the asset instruction. The one asset corresponding to the asset instruction may be rephrased as an asset determined from the asset instruction.

The asset acquiring unit 232 preferably acquires compatible asset information corresponding to the received asset instruction only in the case in which the first determining unit 231 determines that the compatible asset information can be used.

The asset configuring unit 233 configures a compatible asset that is used in the one metaverse, using the compatible asset information acquired by the asset acquiring unit 232. If the compatible asset information is an asset itself to be displayed, the asset configuring unit 233 may perform processing for simply passing the compatible asset information acquired by the asset acquiring unit 232 to the asset output unit 241. It is assumed that such processing is also processing for configuring a compatible asset that is used in the one metaverse. In a similar manner, for example, if the compatible asset information is the address of a blockchain related to an asset to be displayed, the asset configuring unit 233 may perform processing for acquiring a compatible asset from the asset management apparatus 1 (which is an NFT or other suitable type of blockchain) and passing it to the asset output unit 241. It is assumed that such processing is also processing for configuring a compatible asset that is used in the one metaverse.

The asset configuring unit 233 typically configures a compatible asset only in the case in which the first determining unit 231 determines that the user is allowed to use the compatible asset information. The compatible asset and the compatible asset information may only be a blockchain address.

If the compatible asset information acquired by the asset acquiring unit 232 and the compatible asset are the same information, the processing in which the asset configuring unit 233 configures a compatible asset may be processing for passing the compatible asset to the asset output unit 241.

The transmitting unit 24 transmits various types of information. The various types of information are preferably an asset and a metaverse, for example. The transmitting unit 24 transmits a metaverse to the terminal apparatus 3, for example. The transmitting unit 24 transmits a metaverse and one or more assets to the terminal apparatus 3, for example. These assets are preferably compatible assets. The asset is an avatar, for example.

The asset output unit 241 outputs the compatible asset configured by the asset configuring unit 233. The asset output unit 241 typically transmits the compatible asset to the terminal apparatus 3. The compatible asset transmitted by the asset output unit 241 may be the same information as the compatible asset information acquired by the asset acquiring unit 232.

The asset output unit 241 preferably outputs the compatible asset only in the case in which the first determining unit 231 determines that the user is allowed to use the compatible asset information.

Various types of information are stored in the terminal storage unit 31 constituting the terminal apparatus 3. The various types of information are preferably a user identifier, for example.

The terminal accepting unit 32 accepts various types of information, instructions, and other information. The various types of information, instructions, and other information are preferably a metaverse instruction, an asset instruction, a registration instruction, a purchase instruction, and various types of commands, for example.

The various types of commands are preferably a command to operate an avatar, for example. The various types of commands are preferably a command to move an asset such as a door of a building, for example.

In this example, the accepting is a concept that encompasses accepting information input from an input device such as a keyboard, a mouse, or a touch panel, receiving information transmitted via a wired or wireless communication line, accepting information read from a recording medium such as an optical disk, a magnetic disk, or a semiconductor memory, or any other suitable information recording means.

The various types of information, instructions, and other information may be input by any device such as a touch panel, a keyboard, a mouse, or a menu screen, or any other suitable input means.

The terminal processing unit 33 performs various types of processing. The various types of processing are preferably processing for changing the accepted information, instructions, and other information into information, instructions, and other information with a structure for transmission, for example. The various types of processing are preferably processing for changing the received information into information with a structure for output, for example.

The terminal transmitting unit 34 transmits various types of information, instructions, and other information to the asset management apparatus 1 or the information processing apparatus 2. The various types of information, instructions, and other information are preferably an asset instruction, a registration instruction, a purchase instruction, and a login instruction, for example. The terminal transmitting unit 34 transmits an asset instruction to the asset management apparatus 1 or the information processing apparatus 2, for example. The terminal transmitting unit 34 transmits a registration instruction and a purchase instruction to the asset management apparatus 1, for example. The terminal transmitting unit 34 transmits a login instruction to the information processing apparatus 2, for example.

The terminal receiving unit 35 receives various types of information from the information processing apparatus 2. The various types of information are preferably a metaverse and one or more assets, for example. The terminal receiving unit 35 may receive metaverse information for configuring a metaverse. The terminal receiving unit 35 may receive asset information for configuring an asset.

The terminal output unit 36 outputs various types of information. The various types of information are preferably a metaverse and one or more assets, for example. The terminal output unit 36 may output the metaverse or the asset received by the terminal receiving unit 35 as is, or the metaverse or the asset configured by the terminal processing unit 33 using the metaverse information or the asset information received by the terminal receiving unit 35.

In this example, the output is a concept that encompasses display on a display screen, projection using a projector, printing by a printer, output of a sound, transmission to an external apparatus, accumulation in a recording medium, delivery of a processing result to another processing apparatus or another program, or any other suitable output device or means.

The management storage unit 11, the asset storage unit 111, the storage unit 21, the user storage unit 211, and the terminal storage unit 31 are preferably non-volatile recording media, but may alternatively be realized by volatile recording media.

There is no limitation on the procedure in which information is stored in the management storage unit 11 and other units. For example, information may be stored in the management storage unit 11 and other units via a recording medium, information transmitted via a communication line or the like may be stored in the management storage unit 11 and other units, or information input via an input device may be stored in the management storage unit 11 and other units.

The management receiving unit 12, the registration instruction receiving unit 121, the request receiving unit 122, the purchase instruction receiving unit 123, the receiving unit 22, the instruction receiving unit 221, and the terminal receiving unit 35 are typically realized by wireless or wired communication parts, but may also be realized by broadcast receiving parts.

The management processing unit 13, the second determining unit 131, the registration unit 132, the asset determining unit 133, the reward processing unit 134, the processing unit 23, the first determining unit 231, the asset acquiring unit 232, the asset configuring unit 233, and the terminal processing unit 33 are preferably non-volatile recording media, but may alternatively be realized by volatile recording media.

There is no limitation on the procedure in which information is stored in the management processing unit 13 and other units. For example, information may be stored in the management processing unit 13 and other units via a recording medium, information transmitted via a communication line or the like may be stored in the management processing unit 13 and other units, or information input via an input device may be stored in the management processing unit 13 and other units.

The management transmitting unit 14, the asset transmitting unit 141, the transmitting unit 24, the asset output unit 241, and the terminal transmitting unit 34 are typically realized by wireless or wired communication parts, but may alternatively be realized by broadcasting parts.

The terminal accepting unit 32 may consist of a device driver for an input device such as a touch panel or a keyboard, control software for a menu screen, or any other suitable device or means.

The terminal output unit 36 may be considered to include or to not include an output device such as a display screen or a speaker. The terminal output unit 36 may consist of driver software for an output device, a combination of driver software for an output device and the output device, or any other suitable device or means.

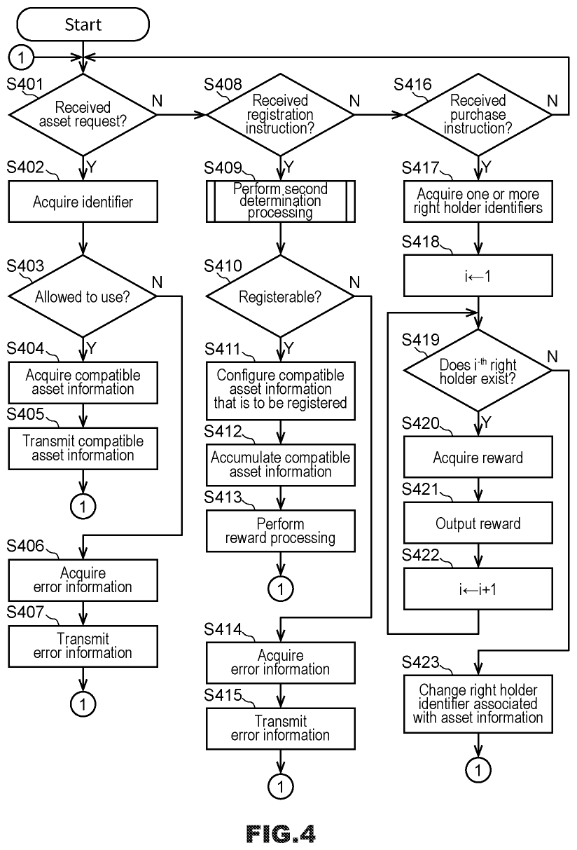

Next, an operation example of the information system A will be described. First, an operation example of the asset management apparatus 1 will be described with reference to the flowchart in FIG. 4.

(Step S401) The request receiving unit 122 determines whether or not it has received an asset request that specifies one metaverse identifier and one asset identifier. If it has received an asset request, the procedure advances to step S402. Alternatively, the procedure advances to step S408. The asset request is associated with a user identifier, for example.

(Step S402) The second determining unit 131 acquires various types of identifiers. The various types of identifiers in this example are preferably a user identifier, a metaverse identifier, and an asset identifier.

(Step S403) The second determining unit 131 determines whether or not a user identified with the user identifier is allowed to use the compatible asset information identified with one metaverse identifier and one asset identifier corresponding to the asset request, using the one or more identifiers acquired in step S402. If it is determined that the user is allowed to use the compatible asset information, the procedure advances to step S404. Alternatively, the procedure advances to step S406.

(Step S404) The asset determining unit 133 acquires compatible asset information identified with the one metaverse identifier and the one asset identifier, from the asset storage unit 111.

(Step S405) The asset transmitting unit 141 transmits the compatible asset information acquired in step S404 to the apparatus that transmitted the asset request (e.g., the information processing apparatus 2 or the terminal apparatus 3). The procedure returns to step S401.

(Step S406) The management processing unit 13 acquires error information indicating that the user is not allowed to use the compatible asset information. The error information is preferably an error message or an error code, for example.

(Step S407) The management transmitting unit 14 transmits the error information acquired in step S406 to the apparatus that transmitted the asset request. The procedure returns to step S401.

(Step S408) The registration instruction receiving unit 121 determines whether or not it has received a registration instruction. If it has received a registration instruction, the procedure advances to step S409. Alternatively, the procedure advances to step S416.

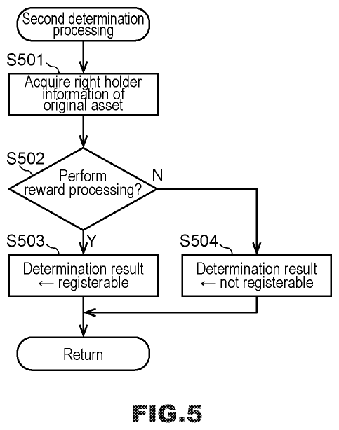

(Step S409) The second determining unit 131 performs second determination processing. An example of the second determination processing will be described with reference to the flowchart in FIG. 5. The second determination processing preferably consists of processing for determining whether or not compatible asset information corresponding to the registration instruction can be registered.

(Step S410) If the determination result in step S409 is “registerable”, the procedure advances to step S411. Alternatively, the procedure advances to step S414.

(Step S411) The registration unit 132 acquires the compatible asset information contained in the registration instruction received in step S408, and associates the compatible asset information with the user identifier and the metaverse identifier that are paired with the registration instruction.

(Step S412) The registration unit 132 accumulates the compatible asset information acquired in step S409, in the asset storage unit 111, in pair with the user identifier and the metaverse identifier.

(Step S413) The reward processing unit 134 performs reward processing. Therefore, the reward processing unit 134 performs processing for providing a reward to a right holder identified with a right holder identifier that is paired with the compatible asset information contained in the registration instruction. The procedure returns to step S401.

The right holder identifier in this case is an identifier of a right holder of original asset information from which the compatible asset information was created. As described above, there is no limitation on the content of the reward processing for providing a reward.

(Step S414) The management processing unit 13 acquires error information indicating that the compatible asset information cannot be registered. The error information is preferably an error message or an error code, for example.

(Step S415) The management transmitting unit 14 transmits the error information acquired in step S414, to the apparatus that transmitted the registration instruction. The procedure returns to step S401.

(Step S416) The purchase instruction receiving unit 123 determines whether or not it has received a purchase instruction. If it has received a purchase instruction, the procedure advances to step S417. Alternatively, the procedure returns to step S401.

(Step S417) The reward processing unit 134 acquires one or more right holder identifiers of asset information corresponding to the purchase instruction. The one or more right holder identifiers preferably include a right holder identifier for identifying each right holder of asset information corresponding to the purchase instruction. The one or more right holder identifiers preferably include right holder identifiers for respectively identifying right holders of one or more pieces of asset information from which asset information corresponding to the purchase instruction was created, for example. The one or more right holder identifiers may include right holder identifiers for identifying right holders of asset information from which one or more pieces of asset information were created, the one or more pieces of asset information being information from which asset information corresponding to the purchase instruction was created.

The reward processing unit 134 acquires one or more right holder identifiers of asset information from the asset management apparatus 1, for example.

(Step S418) The reward processing unit 134 substitutes 1 for a counter i.

(Step S419) The reward processing unit 134 determines whether or not there is an i^{-th} right holder identifier in the one or more right holder identifiers acquired in step S417. If there is an i^{-th} right holder identifier, the procedure advances to step S420. Alternatively, the procedure advances to step S423.

(Step S420) The reward processing unit 134 acquires a reward that is to be given to a right holder identified with the i^{-th} right holder identifier. There is no limitation on the methods for acquiring and calculating a reward that is to be given to a right holder.

(Step S421) The reward processing unit 134 outputs the reward acquired in step S420 in association with the i^{-th} right holder identifier.

(Step S422) The reward processing unit 134 increments the counter i by 1. The procedure returns to step S419.

(Step S423) The management processing unit 13 changes the right holder identifier associated with asset information corresponding to the purchase instruction to a user identifier (purchaser identifier) corresponding to the purchase instruction. The procedure returns to step S401.

In the flowchart in FIG. 4, the processing ends at power off or at an interruption of termination processing.

Next, an example of the second determination processing in step S409 will be described with reference to the flowchart in FIG. 5.

(Step S501) The second determining unit 131 acquires right holder information of the original asset.

(Step S502) The second determining unit 131 determines whether or not to perform reward processing, using the right holder information acquired in step S501. If it is determined that reward processing is to be performed, the procedure advances to step S503. Alternatively, the procedure advances to step S504.

The second determining unit 131 determines that reward processing can be performed, in the case in which the right holder information of the original asset contains the user identifier, for example. The second determining unit 131 determines that reward processing can be performed, in the case in which the registration of the right holder information of the original asset is a flag indicating that the registration is permitted, for example.

(Step S503) The second determining unit 131 substitutes the value “registerable” for the variable “determination result”. The procedure returns to the upper-level processing.

(Step S504) The second determining unit 131 substitutes the value “not registerable” for the variable “determination result”. The procedure returns to the upper-level processing.

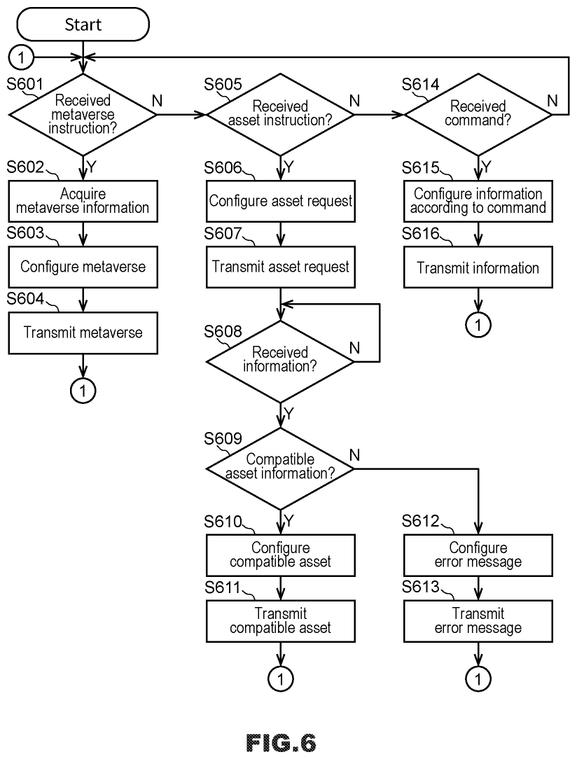

Next, an operation example of the information processing apparatus 2 will be described with reference to the flowchart in FIG. 6.

(Step S601) The instruction receiving unit 221 determines whether or not it has received a metaverse instruction. If it has received a metaverse instruction, the procedure advances to step S602. Alternatively, the procedure advances to step S605.

(Step S602) The processing unit 23 acquires metaverse information from the storage unit 21.

(Step S603) The processing unit 23 configures a metaverse using the metaverse information acquired in step S602. If the terminal apparatus 3 configures a metaverse using the metaverse information, the processing in this step is not necessary.

(Step S604) The transmitting unit 24 transmits the metaverse information or the metaverse to the terminal apparatus 3 that transmitted the metaverse instruction. The procedure returns to step S601.

(Step S605) The instruction receiving unit 221 determines whether or not it has received an asset instruction. If it has received an asset instruction, the procedure advances to step S606. Alternatively, the procedure advances to step S614.

(Step S606) The asset acquiring unit 232 configures an asset request.

(Step S607) The transmitting unit 24 transmits the asset request configured in step S606 to the asset management apparatus 1.

(Step S608) The asset acquiring unit 232 determines whether or not it has received information. If it has received information, the procedure advances to step S609. Alternatively, the procedure returns to step S608.

(Step S609) The asset configuring unit 233 determines whether the information received in step S608 is asset information or error information. If the information is asset information, the procedure advances to step S610. If the information is error information, the procedure advances to step S612. The determination of whether or not the information is asset information in this example is typically determination of whether or not it is compatible asset information.

(Step S610) The asset configuring unit 233 configures a compatible asset using the asset information received in step S608. If the terminal apparatus 3 configures a compatible asset using the compatible asset information, this step is not necessary.

(Step S611) The asset output unit 241 transmits the compatible asset information acquired in step S609 or the compatible asset configured in step S610 to the terminal apparatus 3. The procedure returns to step S601.

(Step S612) The processing unit 23 configures an error message that is to be transmitted, using the received error information.

(Step S613) The transmitting unit 24 transmits the error message configured in step S612 to the terminal apparatus 3. The procedure returns to step S601.

(Step S614) The receiving unit 221 determines whether or not it has received a command. If it has received a command, the procedure advances to step S615. Alternatively, the procedure returns to step S601. The command preferably consists of a command to operate an avatar, for example.

(Step S615) The processing unit 23 configures information according to the command received in step S614. The processing for configuring information according to the command preferably consists of processing for configuring avatar information (asset information) according to a command to operate an avatar, for example.

(Step S616) The transmitting unit 24 transmits the information configured in step S615 to one or more terminal apparatuses 3. The procedure returns to step S601.

The one or more terminal apparatuses 3 in this case are preferably one or more terminal apparatuses 3 other than the terminal apparatus 3 that transmitted the command. It is assumed that the other one or more terminal apparatuses 3 and the terminal apparatus 3 that transmitted the command output the same one metaverse.

In the flowchart in FIG. 6, the processing ends at power off or at an interruption of termination processing.

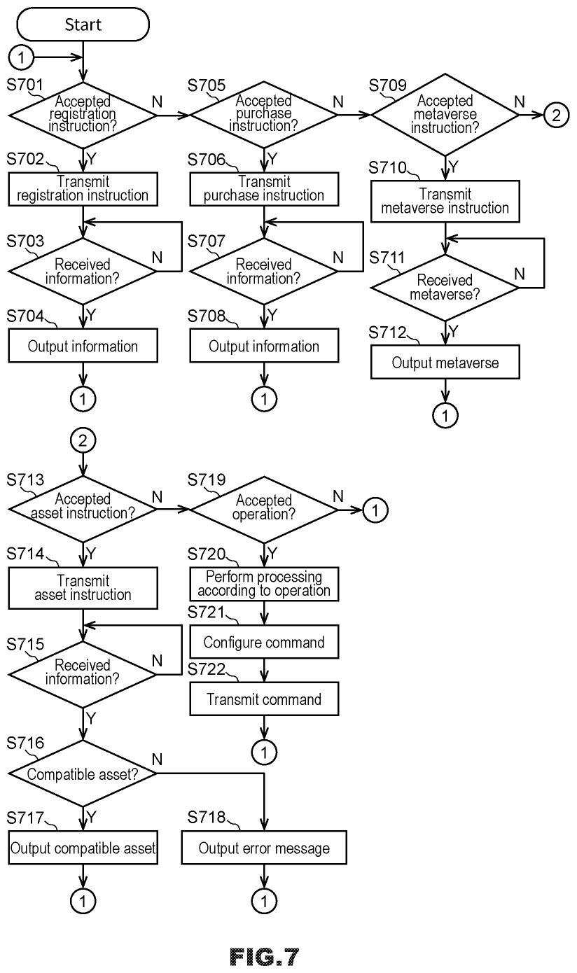

Next, an operation example of the terminal apparatus 3 will be described with reference to the flowchart in FIG. 7.

(Step S701) The terminal accepting unit 32 determines whether or not it has accepted a registration instruction. If it has accepted a registration instruction, the procedure advances to step S702. Alternatively, the procedure advances to step S705. The registration instruction has compatible asset information, an asset identifier of an original asset, a metaverse identifier, and a user identifier, for example.

(Step S702) The terminal processing unit 33 configures a registration instruction that is to be transmitted. The terminal transmitting unit 34 transmits the registration instruction to the asset management apparatus 1.

(Step S703) The terminal receiving unit 35 determines whether or not it has received information. If it has received information, the procedure advances to step S704. Alternatively, the procedure returns to step S703. The information preferably consists of information indicating that the registration of the compatible asset information has been successfully completed, for example.

(Step S704) The terminal processing unit 33 configures information that is to be output, using the information received in step S703. The terminal output unit 36 outputs the information. The procedure returns to step S701.

(Step S705) The terminal accepting unit 32 determines whether or not it has accepted a purchase instruction. If it has accepted a purchase instruction, the procedure advances to step S706. Alternatively, the procedure advances to step S709. The purchase instruction has a compatible asset identifier and a user identifier, for example.

(Step S706) The terminal processing unit 33 configures a purchase instruction that is to be transmitted. The terminal transmitting unit 34 transmits the purchase instruction to the asset management apparatus 1.

(Step S707) The terminal receiving unit 35 determines whether or not it has received information. If it has received information, the procedure advances to step S708. Alternatively, the procedure returns to step S707. The information preferably consists of information indicating that the processing for purchasing the compatible asset has been successfully completed.

(Step S708) The terminal processing unit 33 configures information that is to be output, using the information received in step S707. The terminal output unit 36 outputs the information. The procedure returns to step S701.

(Step S709) The terminal accepting unit 32 determines whether or not it has accepted a metaverse instruction. If it has accepted a metaverse instruction, the procedure advances to step S710. Alternatively, the procedure advances to step S713. The metaverse instruction has a user identifier, for example.

(Step S710) The terminal processing unit 33 configures a metaverse instruction that is to be transmitted. The terminal transmitting unit 34 transmits the metaverse instruction to the information processing apparatus 2. The information processing apparatus 2 to which the metaverse instruction is transmitted is the information processing apparatus 2 that operates the metaverse corresponding to the metaverse instruction.

(Step S711) The terminal receiving unit 35 determines whether or not it has received a metaverse. If it has received a metaverse, the procedure advances to step S712. Alternatively, the procedure returns to step S711. The terminal receiving unit 35 may receive metaverse information.

(Step S712) The terminal output unit 36 outputs the metaverse received in step S711. The procedure returns to step S701. The terminal output unit 36 may output a metaverse configured by the terminal processing unit 33 based on the metaverse information received by the terminal receiving unit 35.

(Step S713) The terminal accepting unit 32 determines whether or not it has accepted an asset instruction. If it has accepted an asset instruction, the procedure advances to step S714. Alternatively, the procedure advances to step S719. The asset instruction has a metaverse identifier, an original asset identifier, and a user identifier, for example.

(Step S714) The terminal processing unit 33 configures an asset instruction that is to be transmitted. The terminal transmitting unit 34 transmits the asset instruction to the information processing apparatus 2 or the asset management apparatus 1.

(Step S715) The terminal receiving unit 35 determines whether or not it has received information. If it has received information, the procedure advances to step S716. Alternatively, the procedure returns to step S715. The terminal receiving unit 35 may receive asset information.

(Step S716) If the information received in step S715 is a compatible asset, the terminal processing unit 33 advances the procedure to step S717. If the information is an error message, the procedure advances to step S718.

(Step S717) The terminal output unit 36 outputs the compatible asset received in step S715. The procedure returns to step S701. The terminal output unit 36 may output an asset configured by the terminal processing unit 33 using the asset information received by the terminal receiving unit 35.

(Step S718) The terminal output unit 36 outputs the error message received in step S715. The procedure returns to step S701.

(Step S719) The terminal accepting unit 32 determines whether or not it has accepted an operation. If it has accepted an operation, the procedure advances to step S720. Alternatively, the procedure returns to step S701. The operation preferably consists of an operation for moving an avatar that is being output, for example.

(Step S720) The terminal processing unit 33 performs processing according to the operation accepted in step S719. The processing according to the operation preferably consists of processing for moving an avatar, for example.

(Step S721) The terminal processing unit 33 configures a command that is to be transmitted to the information processing apparatus 2, based on the operation accepted in step S719.

(Step S722) The terminal transmitting unit 34 transmits the command configured in step S721. The procedure returns to step S701.

In the flowchart in FIG. 7, the processing ends at power off or at an interruption of termination processing.

Hereinafter, a specific operation example of the information system A in this preferred embodiment will be described.

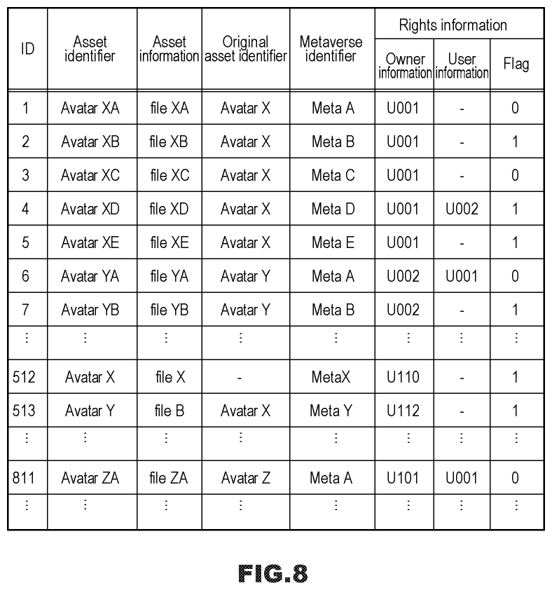

It is assumed that the asset management table shown in FIG. 8 is stored in the asset storage unit 111 of the asset management apparatus 1. The asset management table in this example is a table for managing avatars that are used in two or more metaverses. The asset management table manages two or more records each having “ID”, “asset identifier”, “asset information”, “metaverse identifier”, and “right holder information”. “Right holder information” has “owner information”, “user information”, and “flag”.

“ID” is information for identifying a record. “Asset information” in this example is a file name in which information for configuring an avatar is stored. It is assumed that “asset information” is information in a glTF format, for example. The entity of the file corresponding to the file name is managed in a blockchain, for example. “Asset information” may be a blockchain address of an NFT or other suitable information, and, in this case, it is preferable to indicate which digital token (Ethereum, Polygon, etc.) the address is for. “Right holder information” is information regarding rights related to an avatar identified with an asset identifier. “Owner information” is a user identifier for specifying an owner (including a right holder such as a copyright holder) of a compatible avatar. “User information” is a user identifier of a user who can use a compatible avatar. If the owner of the original asset remains the same and only one of the compatible assets is sold to another owner, it is possible that the owner of the original asset loses ownership of the compatible asset, but can use the compatible asset as long as he/she continues to own the original asset. Therefore, the owner may use the compatible avatar, but the user may not own the compatible avatar. “Flag” is information indicating whether or not the creation of a compatible asset using the avatar is permitted. The flag “1” indicates that the creation of a compatible asset using the avatar as the original asset is permitted. The flag “0” indicates that the creation is not permitted.

Furthermore, in this example, it is assumed that metaverse information identified with the metaverse identifier “MetaA” is stored in the storage unit 21 of an information processing apparatus 2A. It is assumed that metaverse information identified with the metaverse identifier “MetaB” is stored in the storage unit 21 of an information processing apparatus 2B. It is assumed that metaverse information identified with the metaverse identifier “MetaC” is stored in the storage unit 21 of an information processing apparatus 2C. It is assumed that metaverse information identified with the metaverse identifier “MetaD” is stored in the storage unit 21 of an information processing apparatus 2D. It is assumed that metaverse information identified with the metaverse identifier “MetaE” is stored in the storage unit 21 of an information processing apparatus 2E.

In such a situation, the following three specific examples will be described. Specific Example 1 describes a case in which a user inputs an asset instruction requesting the use of a certain avatar in a certain metaverse, to the terminal apparatus 3. Specific Example 2 describes a case in which a user inputs a registration instruction to register compatible asset information derived from asset information of a certain avatar, using the asset information, to the terminal apparatus 3. Specific Example 3 describes a case in which a user inputs a purchase instruction on certain avatar information, to the terminal apparatus 3.

### Specific Example 1

It is assumed that a user identified with the user identifier “U001” inputs the metaverse instruction “<metaverse identifier> MetaA” to the terminal apparatus 3.

Next, the terminal accepting unit 32 of the terminal apparatus 3 accepts the metaverse instruction. The terminal processing unit 33 acquires the user identifier “U001” from the terminal storage unit 31, and configures a metaverse instruction “<user identifier>U001<metaverse identifier>MetaA” that is to be transmitted. The terminal transmitting unit 34 transmits the metaverse instruction to the information processing apparatus 2A corresponding to the metaverse identifier “MetaA”. The terminal transmitting unit 34 further transmits an asset instruction “<user identifier>U001<metaverse identifier>MetaA” similar to the above-mentioned metaverse instruction to the information processing apparatus 2A.

The terminal transmitting unit 34 may transmit the asset instruction to the asset management apparatus 1. In this case, the terminal apparatus 3 may receive the compatible asset from the asset management apparatus 1.

Next, the instruction receiving unit 221 of the information processing apparatus 2A receives the metaverse instruction “<user identifier>U001 <metaverse identifier>MetaA”. The processing unit 23 acquires metaverse information identified with the metaverse identifier “MetaA” from the storage unit 21. The processing unit 23 configures a metaverse using the acquired metaverse information. The transmitting unit 24 transmits the metaverse to the terminal apparatus 3 that transmitted the metaverse instruction.

Furthermore, the instruction receiving unit 221 of the information processing apparatus 2A receives the asset instruction “<user identifier>U001<metaverse identifier>MetaA”. The asset acquiring unit 232 configures an asset request “<user identifier>U001<metaverse identifier>MetaA” using the asset instruction. The asset acquiring unit 232 transmits the configured asset request to the asset management apparatus 1.

Next, the request receiving unit 122 of the asset management apparatus 1 receives the asset request. The second determining unit 131 acquires the user identifier “U001” and the metaverse identifier “MetaA” from the asset request. The second determining unit 131 determines that the asset management table in FIG. 8 contains a record whose owner information or user information has the user identifier “U001”, the record having the metaverse identifier “MetaA”. Therefore, the second determining unit 131 determines that the user identified with the user identifier “U001” can use the asset. Then, the second determining unit 131 acquires asset identifiers “avatar XA” and “avatar ZA” that are each paired with the user identifier “U001” and the metaverse identifier “MetaA”. Then, thumbnail images (not shown) of asset information each paired with the asset identifiers “avatar XA” and “avatar ZA” acquired by the second determining unit 131 are acquired. The transmitting unit 24 transmits a selection menu having the asset identifiers “avatar XA” and “avatar ZA” and the two thumbnail images, to the terminal apparatus 3 of the user identified with the user identifier “U001”.

Next, the terminal receiving unit 35 of the terminal apparatus 3 receives the selection menu. The terminal processing unit 33 configures a selection menu that is to be output. The terminal output unit 36 outputs the selection menu.

Next, it is assumed that the user selects “avatar XA” from the selection menu output to the terminal apparatus 3. Then, the terminal accepting unit 32 of the terminal apparatus 3 accepts the asset instruction “<asset identifier> avatar XA”. The terminal processing unit 33 configures an asset instruction “<user identifier>U001<asset identifier> avatar XA <metaverse identifier>MetaA” that is to be transmitted. The terminal transmitting unit 34 transmits the asset instruction to the information processing apparatus 2.

Next, the instruction receiving unit 221 of the information processing apparatus 2 receives the asset instruction. The asset acquiring unit 232 configures an asset request “<user identifier>U001<asset identifier> avatar XA<metaverse identifier>MetaA”. The transmitting unit 24 transmits the asset request to the asset management apparatus 1.

Next, the request receiving unit 122 of the asset management apparatus 1 receives the asset request. The second determining unit 131 acquires an original asset identifier “avatar X” that is paired with the asset identifier “avatar XA” from the asset management table (FIG. 8). Then, the second determining unit 131 acquires right holder information (owner information) “U110” that is paired with the original asset identifier “avatar X”. In this example, since the right holder information can be acquired, the second determining unit 131 determines that reward processing can be performed. Therefore, the second determining unit 131 determines that the user can use “avatar XA”. The asset determining unit 133 acquires compatible asset information “file XA” identified with “avatar XA”, from the asset management table. The asset transmitting unit 141 transmits the compatible asset information to the information processing apparatus 2 that transmitted the asset request.

Next, the asset acquiring unit 232 of the information processing apparatus 2 acquires the compatible asset information of “avatar XA”. The asset configuring unit 233 configures an avatar of “avatar XA” using the received asset information. The asset output unit 241 transmits the avatar to the terminal apparatus 3.

Next, the terminal receiving unit 35 of the terminal apparatus receives the avatar of “avatar XA”. Then, the terminal output unit 36 outputs the asset onto an already output metaverse.

The reward processing unit 134 of the asset management apparatus 1 preferably performs processing for providing a reward to a user identified with the user identifier “U110”, which is the right holder information of the original asset of the avatar, based on the use of “avatar XA”.

Through the above-described processing, it is possible for a user to use a compatible avatar suitable for a metaverse

### Specific Example 2

It is assumed that a user identified with the user identifier “U001” creates an avatar that can be used with a metaverse identifier “MetaC”, using “avatar XC” as an original asset, and accumulates a file “fileXC_2” in the terminal storage unit 31. Next, it is assumed that the user inputs a registration instruction “<original asset identifier> avatar XC <asset information> fileXC_2” to the terminal apparatus 3.

Next, the terminal accepting unit 32 of the terminal apparatus 3 accepts the registration instruction “<original asset identifier> avatar XC <asset information>fileXC_2”. The terminal processing unit 33 configures a registration instruction “<user identifier>U001<original asset identifier> avatar XC<asset information>fileXC_2” that is to be transmitted. The terminal transmitting unit 34 transmits the registration instruction to the asset management apparatus 1.

Next, the registration instruction receiving unit 121 of the asset management apparatus 1 receives the registration instruction. The second determining unit 131 performs second determination processing as follows. Therefore, the second determining unit 131 acquires the flag “0” in the rights information whose asset identifier is the original asset identifier “avatar XC”, from the asset management table (FIG. 8). The second determining unit 131 determines that the compatible asset information created from the asset identifier “avatar XC” cannot be registered, based on the flag “0”. The management processing unit 13 acquires error information indicating that the compatible asset information cannot be registered. The management transmitting unit 14 transmits the acquired error information to the terminal apparatus 3.

Next, the terminal apparatus 3 receives the error information, and configures an error message that is to be output. The terminal apparatus 3 outputs the error message.

Through the above-described processing, according to this specific example, it is possible to a compatible asset only in the case in which the compatible asset was created from a proper asset.

### Specific Example 3

It is assumed that a user identified with the user identifier “U001” inputs a purchase instruction “<asset identifier> avatar YB<price>$500” to the terminal apparatus 3.

Next, the terminal accepting unit 32 of the terminal apparatus 3 accepts the purchase instruction. The terminal processing unit 33 configures a purchase instruction “<user identifier>U001<asset identifier> avatar YB<price>$500” that is to be transmitted. The terminal transmitting unit 34 transmits the purchase instruction to the asset management apparatus 1.

Next, the purchase instruction receiving unit 123 of the asset management apparatus 1 receives the purchase instruction. The reward processing unit 134 acquires owner information “U002” that is paired with the asset identifier “avatar YB” contained in the purchase instruction, and an owner identifier “U112” that is paired with the original asset identifier “avatar Y” that is paired with the asset identifier “avatar YB”, from the asset management table (FIG. 8).

Next, the reward processing unit 134 acquires a price “$500” from the purchase instruction. The reward processing unit 134 calculates a reward “$300=price×3/5” for the owner “U002” corresponding to the purchase instruction. The reward processing unit 134 calculates a reward “$200=price×2/5” for the owner “U112” of the original asset. In this example, it is assumed that the reward is distributed to the owner of the asset to be purchased and the owner of the original asset from which the asset was created such that the reward is calculated with different weights for the owners. The reward processing unit 134 accumulates rewards (“$300” and “$200”) respectively in association with the user identifiers (“U002” and “U112”) of the users. The reward processing unit 134 performs processing for providing the rewards to the two users.

Next, the management processing unit 13 changes the owner information “U002” associated with the asset information (the asset identifier “avatar YB”) corresponding to the purchase instruction to the user identifier “U001” corresponding to the purchase instruction.

Through the above-described processing, according to this specific example, it is possible to properly purchase and sell an asset so as to provide a reward to a right holder of the original asset as well.

As described above, according to this preferred embodiment, for a specific asset, it is possible for a user to use an asset suitable for a metaverse that is operated by each of the two or more information processing apparatuses 2.

Furthermore, according to this preferred embodiment, for a specific asset, it is possible for a user to select and use one asset out of two or more assets compatible with one metaverse.

Furthermore, according to this preferred embodiment, it is possible to provide an environment in which only a user who has a right to use a compatible asset can use the compatible asset.

Furthermore, according to this preferred embodiment, blockchain techniques are used for managing compatible assets, and thus it is possible to properly manage one asset and a compatible asset corresponding to the one asset.

Furthermore, according to this preferred embodiment, it is possible to provide a platform for making it possible to use a specific asset in each of two or more metaverses.

Furthermore, according to this preferred embodiment, it is possible to register a compatible asset. It is possible to properly perform an operation for registering a compatible asset.

Furthermore, according to this preferred embodiment, it is possible to provide a mechanism for properly providing a reward to a right holder of an original asset in the case in which a compatible asset is sold.

The processing in this embodiment may be realized by software. The software may be distributed by software downloads or any other suitable method. Furthermore, the software may be distributed in a form where the software is stored in a recording medium such as a CD-ROM. The same applies to other embodiments in this specification. The software that realizes the asset management apparatus 1 in this embodiment is the following sort of program. Specifically, this program is a program for causing a computer capable of accessing an asset storage unit in which two or more pieces of compatible asset information are stored in association with any one metaverse identifier of two or more metaverse identifiers and any one asset identifier of one or more asset identifiers, to function as: a request receiving unit that receives an asset request that specifies one metaverse identifier and one asset identifier; an asset determining unit that determines compatible asset information corresponding to the one metaverse identifier and the one asset identifier specified with the asset request, from the asset storage unit; and an asset transmitting unit that transmits the compatible asset information determined by the asset determining unit.

The software that realizes the information processing apparatus 2 in this embodiment is the following sort of program. Specifically, this program is a program for causing a computer to function as: an instruction receiving unit that receives an asset instruction, which is an instruction to use a specific asset; an asset acquiring unit that acquires compatible asset information corresponding to the one metaverse and the specific asset, from an asset storage unit in which compatible asset information regarding a compatible asset corresponding to one asset is stored in association with each of two or more metaverses; an asset configuring unit that configures a compatible asset that is used in the one metaverse, using the compatible asset information acquired by the compatible asset acquiring unit; and an asset output unit that outputs the compatible asset configured by the asset configuring unit.

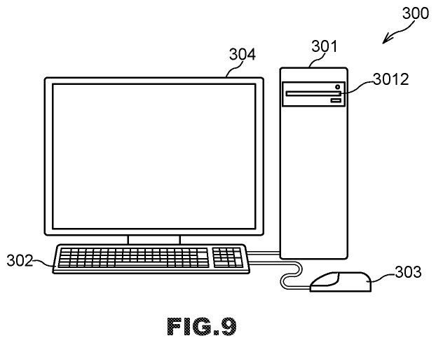

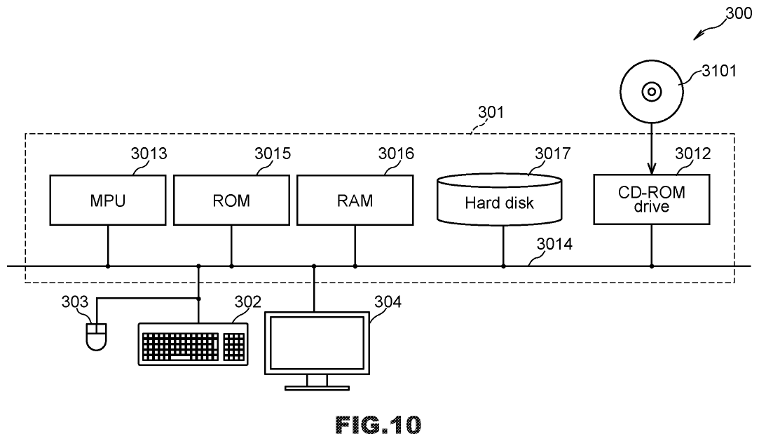

FIG. 9 shows the external appearance of a preferred computer that executes the program described in this specification to realize the asset management apparatus 1, the information processing apparatuses 2, and other apparatuses in their various embodiments. The foregoing embodiments of the information system may be realized using computer hardware and a computer program executed thereon. FIG. 9 is a schematic view of a computer system 300. FIG. 10 is a block diagram of the system 300.

In FIG. 9, the computer system 300 includes a computer 301 including a compact disc read only memory (CD-ROM) drive, a computer keyboard 302, a computer mouse 303, and a computer monitor 304.

In FIG. 10, the computer 301 includes, in addition to the CD-ROM drive 3012, an MPU 3013, a bus 3014 connected to the CD-ROM drive 3012 or equivalent, a read-only memory unit (ROM) 3015 in which a program such as a boot up program is stored, a random access memory unit (RAM) 3016 that is connected to the MPU 3013 and is a memory in which a command of an application program is temporarily stored and a temporary storage area is provided, and a hard disk 3017 in which an application program, a system program, and data are stored. Although not shown, the computer 301 may further include a network card that provides connection to a local area network (LAN).

The program for causing the computer system 300 to execute the functions of the asset management apparatus 1 and the like in the foregoing embodiments may be stored in a CD-ROM 3101 that is inserted into the CD-ROM drive 3012, and be transmitted to the hard disk 3017. Alternatively, the program may be transmitted via a network (not shown) to the computer 301 and stored in the hard disk 3017. At the time of execution, the program is loaded into the RAM 3016. The program may be loaded from the CD-ROM 3101. Alternately, the program may be loaded directly from a network.

The program does not necessarily have to include, for example, an operating system (OS) or a third party program to cause the computer 301 to execute the functions of the asset management apparatus 1 and the like in the foregoing embodiments. The program may only include a command portion to call an appropriate function (module) in a controlled mode and obtain desired results. The manner in which the computer system 300 operates is well known, and thus a detailed description thereof has been omitted.

It should be noted that, in the program, in a step of transmitting information, a step of receiving information, or the like, processing that is performed only by hardware is not included. For example, processing performed by a modem or an interface card in the transmitting step (processing that can be performed only by hardware) is not included.

Furthermore, the information processing apparatus that executes the program may consist of a single computer, or the information processing apparatus may consist of multiple computers. Therefore, centralized processing may be performed, or distributed processing may be performed, respectively.

Furthermore, in the foregoing embodiments, it will be appreciated that at least two communication parts in one apparatus may be physically realized by one medium.

In the foregoing embodiments, each process may be realized as centralized processing using a single information processing apparatus, or may be realized as distributed processing using multiple information processing apparatuses. Therefore, for example, each of the asset management apparatus 1 and the information processing apparatuses 2 may be realized by two or more apparatuses.

The present invention is not limited to the embodiment set forth herein. Various modifications are possible within the scope of the present invention.

### INDUSTRIAL APPLICABILITY

As described above, the asset management apparatus 1 according to the present invention enables an environment in which, for a specific asset, an asset compatible with each of two or more metaverses can be used, thereby allowing a user to use the specific asset in the two or more metaverses, thus rendering this apparatus useful as a server constituting a metaverse system and the like.

### LIST OF REFERENCE NUMERALS

A Information system
1 Asset management apparatus
2 Information processing apparatus
3 Terminal apparatus
11 Management storage unit
12 Management receiving unit
13 Management processing unit
14 Management transmitting unit
21 Storage unit
22 Receiving unit
23 Processing unit
24 Transmitting unit
31 Terminal storage unit
32 Terminal accepting unit
33 Terminal processing unit
34 Terminal transmitting unit
35 Terminal receiving unit
36 Terminal output unit
111 Asset storage unit
121 Registration instruction receiving unit
122 Request receiving unit
123 Purchase instruction receiving unit
131 Second determining unit
132 Registration unit
133 Asset determining unit
134 Reward processing unit
141 Asset transmitting unit
211 User storage unit
221 Instruction receiving unit
231 First determining unit
232 Asset acquiring unit
233 Asset configuring unit
241 Asset output unit

1. An information processing apparatus for realizing one metaverse, comprising:
an instruction receiving unit that receives an asset instruction, which is an instruction to use a specific asset;
an asset acquiring unit that acquires compatible asset information corresponding to the one metaverse and the specific asset, out of two or more pieces of compatible asset information corresponding to the specific asset;
an asset configuring unit that configures a compatible asset that is used in the one metaverse, using the compatible asset information acquired by the asset acquiring unit; and
an asset output unit that outputs the compatible asset configured by the asset configuring unit.

2. The information processing apparatus according to claim 1, wherein the asset acquiring unit acquires the compatible asset information from an asset storage unit in which compatible asset information regarding a compatible asset corresponding to one asset is stored in association with each of two or more metaverses.

3. The information processing apparatus according to claim 2,
wherein two or more pieces of compatible asset information are stored in the asset storage unit in association with the one metaverse and the one asset,
the asset instruction has an asset identifier for identifying one piece of compatible asset information out of the two or more pieces of compatible asset information, and
the asset acquiring unit acquires the compatible asset information corresponding to the one metaverse and the one asset corresponding to the asset instruction and identified with the asset identifier, from the asset storage unit.

4. The information processing apparatus according to claim 2,
wherein rights information for specifying a user who is allowed to use the compatible asset information is managed in association with the compatible asset information in the asset storage unit,
the instruction receiving unit receives the asset instruction in association with a user identifier for identifying a user,
the information processing apparatus further comprises a first determining unit that determines whether or not the user identified with the user identifier corresponding to the asset instruction is allowed to use the compatible asset information, using the rights information associated with the compatible asset information corresponding to the one metaverse and the one asset corresponding to the asset instruction, and
the asset output unit outputs the compatible asset only in a case in which the first determining unit determines that the user is allowed to use the compatible asset information.

5. The information processing apparatus according to claim 4,
wherein the two or more pieces of compatible asset information and the rights information are managed using a mechanism of a blockchain, and
the first determining unit refers to the rights information managed in the blockchain and determines whether or not the user is allowed to use the compatible asset information.

6. An asset management apparatus comprising:
an asset storage unit in which two or more pieces of compatible asset information are stored in association with any one metaverse identifier of two or more metaverse identifiers and any one asset identifier of one or more asset identifiers;
a request receiving unit that receives an asset request that specifies one metaverse identifier and one asset identifier;
an asset determining unit that determines compatible asset information corresponding to the one metaverse identifier and the one asset identifier specified with the asset request, from the asset storage unit; and
an asset transmitting unit that transmits the compatible asset information determined by the asset determining unit.

7. The asset management apparatus according to claim 6, further comprising:
a registration instruction receiving unit that receives a registration instruction, which is an instruction to register compatible asset information regarding a compatible asset using the one asset, the registration instruction specifying one metaverse identifier; and
a registration unit that accumulates the compatible asset information in the asset storage unit in association with the one metaverse identifier and the asset identifier of the one asset, in response to receipt of the registration instruction.

8. The asset management apparatus according to claim 7, further comprising:
a second determining unit that determines whether or not it is possible to perform reward processing, which is processing for providing a reward for the one asset, in response to accumulation of the compatible asset information by the registration unit,
wherein the registration unit registers the compatible asset information in the asset storage unit only in a case in which the second determining unit determines that it is possible to perform reward processing.

9. The asset management apparatus according to claim 6,
wherein a right holder identifier for identifying a right holder of an asset is managed in association with the one asset and each of the compatible asset information, and
the asset management apparatus further comprises:
a purchase instruction receiving unit that receives a purchase instruction on a compatible asset corresponding to the compatible asset information; and
a reward processing unit that performs processing for providing a reward to both a right holder identified with a right holder identifier that is paired with the compatible asset corresponding to the purchase instruction and a right holder identified with a right holder identifier that is paired with the one asset that is paired with the compatible asset.

10. The asset management apparatus according to claim 6, wherein all or any of the asset storage unit, the second determining unit, the registration instruction receiving unit, the purchase instruction receiving unit, the reward processing unit, the asset determining unit, and the asset transmitting unit uses a mechanism of a blockchain.

11. An information processing method realized using an instruction receiving unit, an asset acquiring unit, an asset configuring unit, and an asset output unit, comprising:
an instruction receiving step of the instruction receiving unit receiving an asset instruction, which is an instruction to use a specific asset;
an asset acquiring step of the asset acquiring unit acquiring compatible asset information corresponding to the one metaverse and the specific asset, out of two or more pieces of compatible asset information corresponding to the specific asset;
an asset configuring step of the asset configuring unit configuring a compatible asset that is used in the one metaverse, using the compatible asset information acquired in the asset acquiring step; and
an asset output step of the asset output unit outputting the compatible asset configured in the asset configuring step.

12. An asset management method realized using an asset storage unit in which two or more pieces of compatible asset information are stored in association with any one metaverse identifier of two or more metaverse identifiers and any one asset identifier of one or more asset identifiers, a request receiving unit, an asset determining unit, and an asset transmitting unit, comprising;
a request receiving step of the request receiving unit receiving an asset request that specifies one metaverse identifier and one asset identifier;
an asset determining step of the asset determining unit determining compatible asset information corresponding to the one metaverse identifier and the one asset identifier specified with the asset request, from the asset storage unit; and
an asset transmitting step of the asset transmitting unit transmitting the compatible asset information determined in the asset determining step.

13. A recording medium on which a program is recorded, the program causing a computer to function as;
an instruction receiving unit that receives an asset instruction, which is an instruction to use a specific asset;
an asset acquiring unit that acquires compatible asset information corresponding to the one metaverse and the specific asset, out of two or more pieces of compatible asset information corresponding to the specific asset;
an asset configuring unit that configures a compatible asset that is used in the one metaverse, using the compatible asset information acquired by the asset acquiring unit; and
an asset output unit that outputs the compatible asset configured by the asset configuring unit.

14. A recording medium on which a program is recorded, the program causing a computer capable of accessing an asset storage unit in which two or more pieces of compatible asset information are stored in association with any one metaverse identifier of two or more metaverse identifiers and any one asset identifier of one or more asset identifiers, to function as:
a request receiving unit that receives an asset request that specifies one metaverse identifier and one asset identifier;
an asset determining unit that determines compatible asset information corresponding to the one metaverse identifier and the one asset identifier specified with the asset request, from the asset storage unit; and
an asset transmitting unit that transmits the compatible asset information determined by the asset determining unit.
